(19) United States
(12) Patent Application Publication
(10) Pub. No.: US 2016/0280582 A1
(43) Pub. Date: Sep. 29, 2016

(54) TOUGHENED GLASS CUTTING METHOD AND TOUGHENED GLASS CUTTING APPARATUS

(71) Applicant: CORNING PRECISION MATERIALS CO., LTD., Chungchengnam-do (KR)

(72) Inventors: Jae Chang Lee, Chungcheongnam-do (KR); Young Seon Park, Chungcheongnam-do (KR); Yong Won Lee, Chungcheongnam-do (KR); Sang Mo Kim, Chungcheongnam-do (KR); Yun Mi Kim, Chungcheongnam-do (KR)

(73) Assignee: Corning Precision Materials Co., Ltd., Chungcheongnam-do (KR)

(21) Appl. No.: 15/034,073

(22) PCT Filed: Nov. 4, 2014
(86) PCT No.: PCT/KR2014/010476

§ 371 Date: May 3, 2016

(30) Foreign Application Priority Data
Nov. 4, 2013 (KR) 10-2013-0132895

(51) Int. Cl. C03B 33/09; C03B 33/033

(52) U.S. Cl. CPC C03B 33/09; C03B 33/033

(57) ABSTRACT

The present invention relates to a toughened glass cutting method and a toughened glass cutting apparatus and, more specifically, to a toughened glass cutting method and a toughened glass cutting apparatus for subdividing toughened disk glass into unit glass. To this end, the present invention provides a toughened glass cutting method, characterized by comprising: a crack formation step for forming at least one crack on a cutting line of toughened glass to be cut; and a cutting step for cutting the toughened glass along the cutting line by heating the cutting line of the toughened glass.

### BACKGROUND OF THE INVENTION

1. Field of the Invention

The present invention relates to a method and apparatus for cutting toughened glass, and more particularly, to a method and apparatus for cutting toughened glass able to divide a toughened glass plate into unit pieces of glass.

2. Description of Related Art

Glass is treated as an indispensable component in a variety of technological and industrial fields, including imaging and optical devices such as monitors, cameras, video tape recorders (VTRs) and mobile phones, transportation equipment such as vehicles, a variety of dishes and construction facilities. Accordingly, glass products having a variety of properties that meet the requirements of respective industrial fields are manufactured and used.

In particular, currently, in response to rapid spread of smartphones, the use of touchscreen panels especially in mobile displays is rapidly increasing. Cover glasses or cover windows used in touchscreen panels are made of toughened glass since high light transmittance and superior mechanical durability are required considering their functions.

Toughened glass is manufactured by a physical toughening method, also referred to as air-cooled toughening, that is mainly applied to safety glasses for vehicles or a chemical toughening method. The chemical toughening method can be applied to a thin glass sheet having a complicated shape or a thickness of about 2 mm or less. The chemical toughening method is a method that improves the strength and hardness of a glass by substituting alkali ions having a smaller ion radius (generally Na ions) with alkali ions having a larger ion radius (generally K ions) in preset conditions.

FIG. 1 is a conceptual cross-sectional view schematically illustrating chemically-toughened glass.

As illustrated in FIG. 1, a compressive stress (CS) layer is formed on the surface of the chemically-toughened glass due to chemical toughening, and a tensile stress (TS) layer or a central tension (CT) layer is formed inside the glass due to a reaction. Bending strength and mechanical strength are increased by high compressive stress on the glass surface.

Toughened glass is manufactured by the process of cutting and machining a raw glass plate before being toughened since it is difficult to mechanically cut the toughened glass or machine the contour of the toughened glass considering the characteristics of the toughened glass and the absence of machining techniques. However, this method has drawbacks in that production costs such as personnel expenses are high due to a large number of manual processes and productivity is low due to a high breakage ratio of half-finished products. Furthermore, since the importance of the yield is increasing due to the increasing size of mobile displays, it is more difficult to apply this method of toughening the glass after cutting and machining it to a mass production process.

Accordingly, the development of technologies for cutting and machining a raw glass plate after toughening it is actively underway.

However, it is generally impossible to cut a chemically-toughened glass using a mechanical wheel when the toughened glass has a depth of layer (DOL) of about 20 μm or greater and a surface compressive stress of 600 MPa or greater. This is because a median crack is not uniformly formed and a large amount of chipping occurs on the glass surface when the toughened glass having a DOL of about 20 μm or greater and a compressive stress of 600 MPa or greater on the surface is wheel-scribed.

In order to overcome these problems, a cutting technology using a laser was developed.

Although the technology of cutting a toughened glass using a CO₂ laser has an advantage in that superior bending strength can be maintained since the toughened glass can be smoothly cut without a surface damage, only straight cutting is possible, which is problematic. In addition, although the process of cutting a toughened glass using an ultra fast laser has an advantage in that the glass can be freely machined to any shape, there are drawbacks in that the cutting speed is very slow and cutting equipment is very expensive. Related Art Document

Patent Document 1: Korean Patent Application Publication No. 10-2011-0086475 (Jul. 28, 2011)

### BRIEF SUMMARY OF THE INVENTION

Various aspects of the present invention provide a method and apparatus for cutting toughened glass able to improve cutting quality and productivity.

In an aspect of the present invention, provided is a method of cutting toughened glass. The method includes the following steps of: forming one or more cracks on a cutting line of a toughened glass plate to be cut; and cutting the toughened glass plate along the cutting line by heating the toughened glass plate along the cutting line.

The step of cutting the toughened glass plate may be carried out while cooling one surface of the toughened glass plate facing away from the other surface of the toughened glass plate that is being heated.

The step of cutting the toughened glass plate may be carried out while heating the cutting line at a temperature ranging from 300 to 700° C.

In addition, a plurality of the cutting lines may be provided on the toughened glass plate. The step of forming the one or more cracks may include forming one or more cracks on each of the cutting lines.

In another aspect of the present invention, provided is an apparatus for cutting toughened glass. The apparatus includes: a crack forming unit forming a crack on a cutting line of a toughened glass plate to be cut; and a heating unit heating the cutting line by contact with the cutting line.

The heating unit may include a body and a heating wire attached to the body. The shape of the heating wire is identical to the shape of the cutting line of the toughened glass plate. The heating wire is to come into contact with the cutting line. The body may be made of an insulating material.

The heating unit may include a body having a contact part and a heater heating the body. The shape of the contact part is identical to the shape of the cutting line of the toughened glass plate. The contact part is to come into contact with the cutting line. The heater may be disposed within the body.

The apparatus may further include a support unit supporting the toughened glass plate to be cut, the support unit cooling the toughened glass plate to be cut.

The heating unit may have a three-dimensional shape.

In addition, a plurality of the heating units may be provided.

According to the present as set forth above, it is possible to improve the quality and productivity of the cutting operation of toughened glass.

In addition, it is possible to freely cut toughened glass to a linear or curved shape.

### BRIEF DESCRIPTION OF THE DRAWINGS

FIG. 1 is a conceptual cross-sectional view schematically illustrating chemically-toughened glass;

FIG. 2 is a flowchart schematically illustrating a method of cutting toughened glass according to an exemplary embodiment of the present invention;

FIG. 3 is a conceptual view illustrating cracks formed on cutting lines of a toughened glass plate according to an exemplary embodiment of the present invention;

FIG. 4 is a conceptual view illustrating heating wires for heating the cutting lines of the toughened glass plate illustrated in FIG. 3;

FIG. 5 and FIG. 6 are pictures taken from the cross-section and the planar surface of cut toughened glass according to an exemplary embodiment of the present invention;

FIG. 7 is a graph illustrating cutting times according to the temperatures at which cutting lines are heated;

FIG. 8 is a conceptual configuration view illustrating an apparatus for cutting toughened glass according to an exemplary embodiment of the present invention;

FIG. 9 and FIG. 10 are schematic cross-sectional views illustrating the heating unit illustrated in FIG. 8; and

FIG. 11 is a conceptual view illustrating an apparatus for cutting toughened glass in which a plurality of heating units are arranged according to an exemplary embodiment of the present invention.

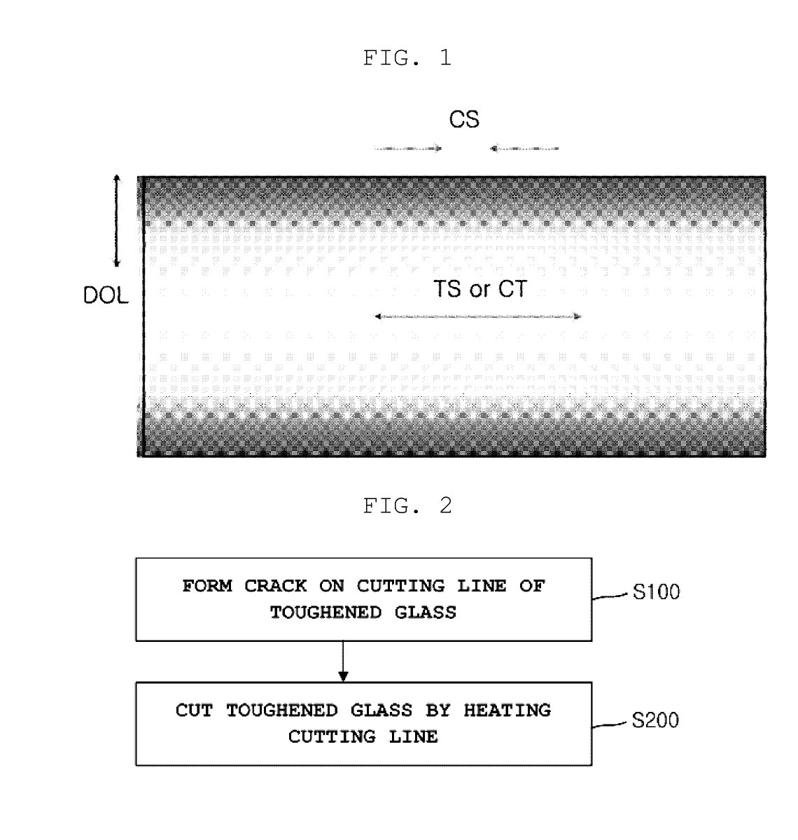

### DETAILED DESCRIPTION OF THE INVENTION

Reference will now be made in detail to a method and apparatus for cutting toughened glass according to the present invention, embodiments of which are illustrated in the accompanying drawings and described below, so that a person skilled in the art to which the present invention relates could easily put the present invention into practice.

Throughout this document, reference should be made to the drawings, in which the same reference numerals and signs are used throughout the different drawings to designate the same or similar components. In the following description of the present invention, detailed descriptions of known functions and components incorporated herein will be omitted in the case that the subject matter of the present invention is rendered unclear.

FIG. 2 is a flowchart schematically illustrating a method of cutting toughened glass according to an exemplary embodiment of the present invention.

As illustrated in FIG. 2, the a method of cutting toughened glass according to this embodiment includes a crack forming step S100 and a cutting step S200.

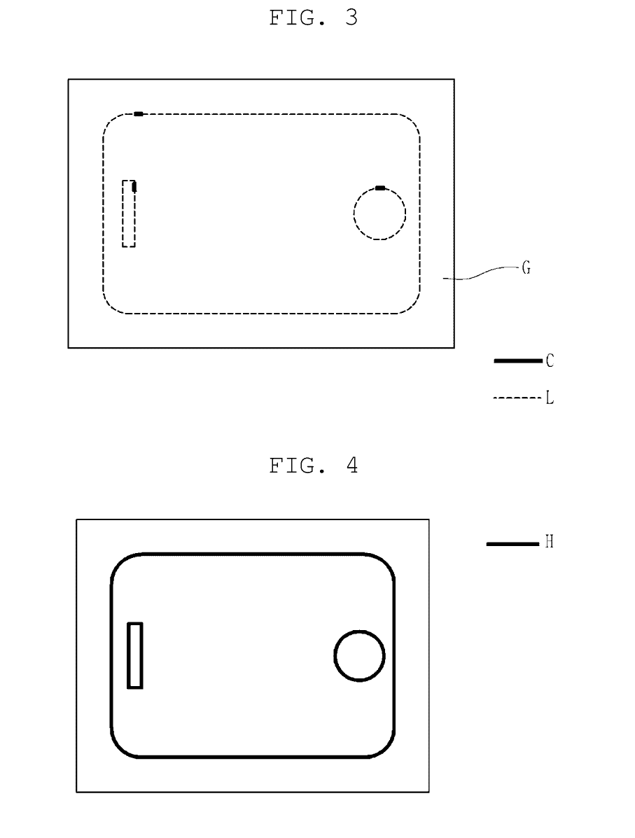

As illustrated in FIG. 3, in order to cut a toughened glass plate G to an intended shape, one or more cracks C are formed on cutting lines L of the toughened glass plate G to be cut (S100).

The toughened glass plate G is made by forming a compressive stress in a raw glass plate such that the strength and hardness thereof are increased. The toughened glass plate refers to the glass plate that is toughened by forming a compressive stress on the surface thereof by, for example, chemical toughening or thermal toughening. When the toughened glass plate G is to be cut into pieces of toughened glass for use as cover glasses of display devices, the bezels and/or transparent electrode patterns of cover glasses may be formed on the toughened glass plate G.

The cutting lines L are imaginary lines drawn on the toughened glass plate G to be cut, and can be one or more straight lines, curves or closed curves.

The cracks C are formed at intended positions on the cutting lines L, and can be formed by a variety of methods, for example, using a scribing wheel or a laser.

When there is a plurality of cutting lines L, one or more cracks C are formed on each of the cutting lines L.

Afterwards, the toughened glass plate G is cut along the cutting lines L by heating the cutting lines L of the toughened glass plate G (S200).

As illustrated in FIG. 4, the cutting lines L may be heated by brining heating wires H having the same shape as the cutting lines L into contact with the cutting lines L.

When the cutting lines L are heated in this fashion, a compressive stress is formed on the surface of the toughened glass plate G due to thermal expansion, whereas a tensile stress is formed under the surface due to a reaction to the thermal expansion of the surface. This tensile stress overlaps and works with a central tension already present within the toughened glass plate G to propagate the cracks C formed on the surface of the toughened glass plate G and direct the propagation of the cracks C, thereby cutting the toughened glass plate G. That is, when the cutting lines L having the cracks C are heated, the toughened glass plate G is cut along the heated cutting lines L within several to tens of seconds.

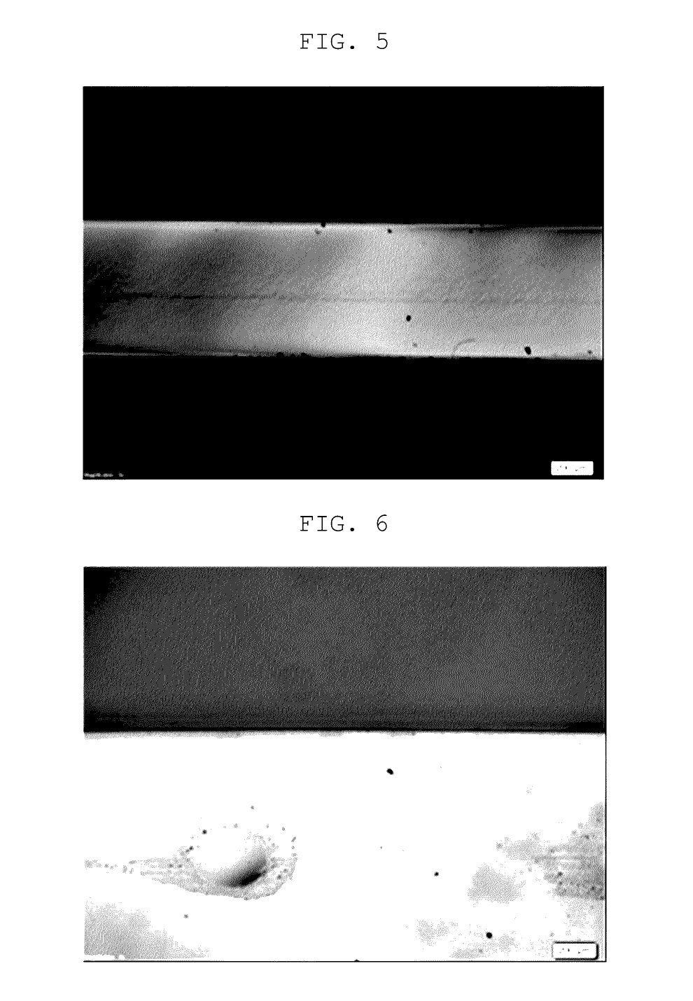

FIG. 5 is a picture taken from the cross-section of a piece of toughened glass cut by the method of cutting toughened glass according to this embodiment, the toughened glass having a surface compressive stress of 725 MPa and a toughening depth of 43 μm, and FIG. 6 is picture taken from the planar surface of the same toughened glass. It is apparent from FIG. 5 and FIG. 6 that, when the toughened glass is cut by the method of cutting toughened glass according to this embodiment, the cut section of the toughened glass is smooth and the surface of the toughened glass has no damages.

The heating temperature can be toughening depth and the central tension of the toughened glass.

It is preferable that the cutting lines L of the toughened glass is heated at a temperature ranging from 300 to 700° C. at the cutting step S200.

FIG. 7 is a graph illustrating the cutting times of toughened glass plates according to the heating temperatures thereof. In FIG. 7, “a” indicates a toughened glass plate having a surface compressive stress of 645 MPa, a toughening depth of 37.7 μm and a central tension of 39.1 MPa, and “b” indicates a toughened glass plate having a surface compressive stress of 651 MPa, a toughening depth of 19.9 μm and a central tension of 19.7 MPa.

As illustrated in FIG. 7, it is appreciated that the higher the heating temperature of the cutting line L of the toughened glass is, the shorter the cutting time is. Specifically, the cutting time of the toughened glass plate G decreases as the heating temperature increases, since the tensile stress caused by heat increases as the heating temperature increases.

In addition, the higher the heating temperature is, the better the straightness of cutting is. Specifically, the straightness of cutting can be improved as the heating temperature increases, since the time for heat transfer to the portions other than the cutting line L decreases as the heating temperature increases.

Furthermore, the greater the toughening depth or the central tension is, the shorter the cutting time is. It is apparent that the cutting time for the toughened glass plate G decreases as the central tension present in the toughened glass plate G increases. In addition, the cutting time of the toughened glass plate G decreases as the toughening depth increases, since the central tension increases as the toughening depth increases.

In the method of cutting toughened glass according to this embodiment, the cutting step S200 can be carried out while cooling one surface of the toughened glass plate G facing away from the other surface of the toughened glass plate G that is being heated.

In this fashion, it is possible to prevent the portions other than the cutting line from being heated by radiation by cooling the surface facing away from the heated surface, thereby improving the efficiency and straightness of cutting.

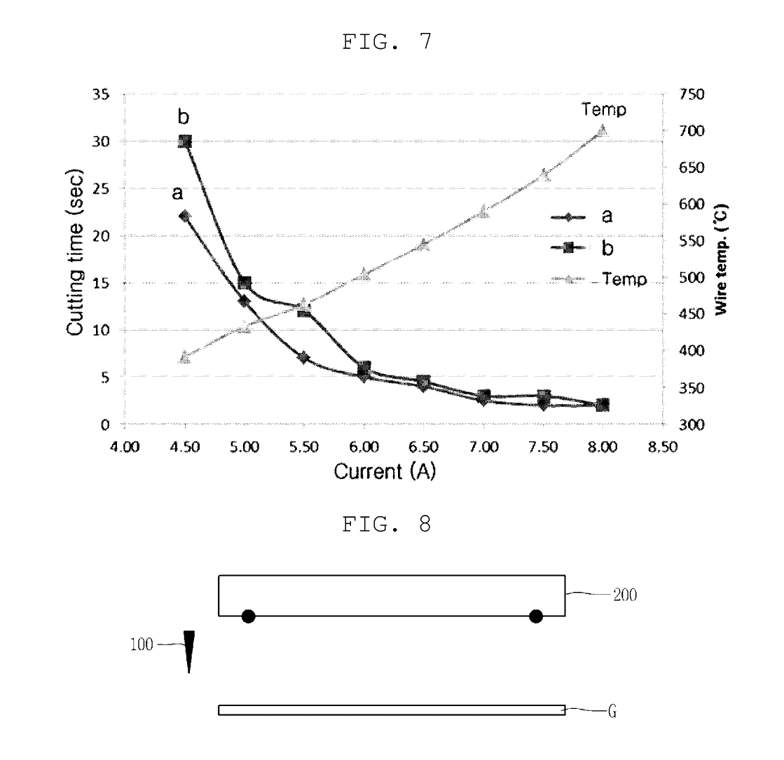

FIG. 8 is a conceptual configuration view illustrating an apparatus for cutting toughened glass according to an exemplary embodiment of the present invention.

As illustrated in FIG. 8, the apparatus for cutting toughened glass according to this embodiment includes a heating unit 200 and a crack forming unit 100.

The crack forming unit 100 forms one or more cracks at one or more intended positions of a cutting line of a toughened glass plate G to be cut.

The crack forming unit 100 may be implemented as a scribing wheel, a laser or the like.

The crack forming unit 100 can form cracks on the cutting line of the toughened glass plate G while moving forwards and backwards, laterally, and upwards and downwards with respect to the toughened glass plate G. Alternatively, the crack forming unit 100 can form cracks on the cutting line of the toughened glass plate G while the toughened glass plate G is moving forwards and backwards, laterally, and upwards and downwards with respect to the crack forming unit 100.

The heating unit 200 comes into contact with the cutting line of the toughened glass plate G and subsequently heats the cutting line.

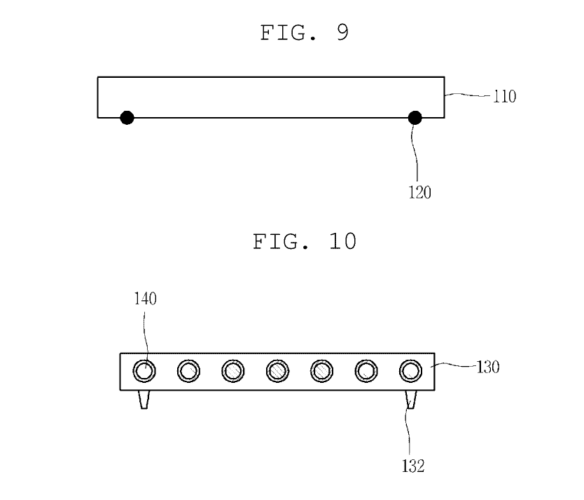

An embodiment of the heating unit 200 is illustrated in FIG. 9. Referring to FIG. 9, the heating unit 200 includes a body 110 and a heating wire 120 attached to the body 110. The heating wire 120 has the same shape as the cutting line of a toughened glass plate, and can come into contact with the cutting line when heating the cutting line. In this case, it is preferable that the body is made of an insulating material. The heating wire 120 may be implemented, for example, as an electrical resistance wire inserted into the body 110.

A modified embodiment of the heating unit 200 is illustrated in FIG. 10. Referring to FIG. 10, the heating unit 200 includes a body 130 and a heater 140 for heating the body 130. The body 130 includes a contact part 132 having the same shape as the cutting line of a toughened glass plate, and can come into contact with the cutting line. The heater 140 can be disposed within the body 130, and can be implemented as a cartridge heater.

The heating unit 200 can have a three-dimensional shape. Since the heating unit 200 has a 3D shape corresponding to the toughened glass plate having a 3D shape, it is possible to cut the toughened glass plate having the 3D shape, thereby facilitating the fabrication of 3D cover glasses.

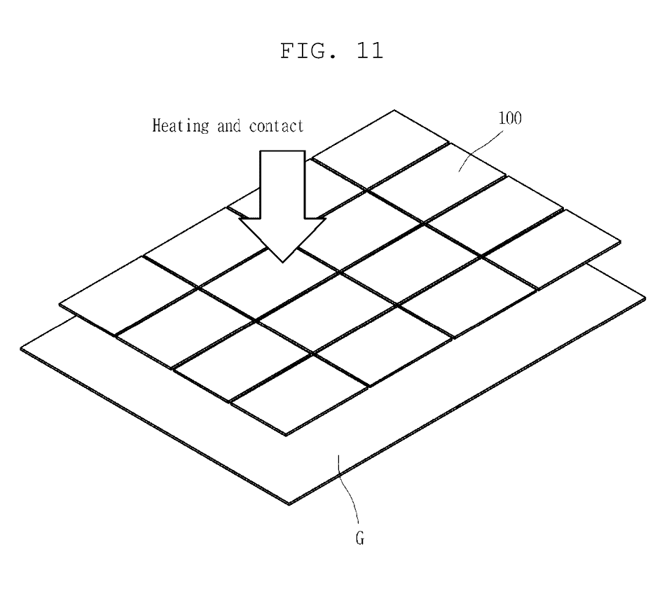

The heating unit 200 may be provided as a plurality of heating units 200, as illustrated in FIG. 11. Since the plurality of heating units 200 is arranged, it is possible to cut a toughened glass plate into a plurality of cells by a single process.

The apparatus for cutting toughened glass according to this embodiment may further include a support unit (not shown) that supports a toughened glass plated to be cut. The support unit is also configured to cool the toughened glass to be cut.

The support unit as described above can contribute to the improved efficiency and straightness of cutting.

The foregoing descriptions of specific exemplary embodiments of the present invention have been presented with respect to the drawings. They are not intended to be exhaustive or to limit the present invention to the precise forms disclosed, and obviously many modifications and variations are possible for a person having ordinary skill in the art in light of the above teachings.

It is intended therefore that the scope of the present invention not be limited to the foregoing embodiments, but be defined by the Claims appended hereto and their equivalents.

What is claimed is:

1. A method of cutting toughened glass comprising:
forming at least one crack on a cutting line of a toughened glass plate to be cut; and
cutting the toughened glass plate along the cutting line by heating the toughened glass plate along the cutting line.

2. The method according to claim 1, wherein cutting the toughened glass plate is carried out while cooling one surface of the toughened glass plate facing away from the other surface of the toughened glass plate that is being heated.

3. The method according to claim 1, wherein cutting the toughened glass plate is carried out while heating the cutting line at a temperature ranging from 300 to 700° C.

4. The method according to claim 1, wherein
a plurality of the cutting lines is provided on the toughened glass plate, and
forming the at least one crack comprises forming at least one crack on each of the cutting lines.

5. An apparatus for cutting toughened glass comprising:
a crack forming unit forming a crack on a cutting line of a toughened glass plate to be cut; and
a heating unit heating the cutting line by contact with the cutting line.

6. The apparatus according to claim 5, wherein the heating unit comprises:
a body; and
a heating wire fixed to the body, a shape of the heating wire being identical to a shape of the cutting line of the toughened glass plate, wherein the heating wire is to come into contact with the cutting line.

7. The apparatus according to claim 6, wherein the body comprises an insulating material.

8. The apparatus according to claim 5, wherein the heating unit comprises:
a body having a contact part, a shape of the contact part being identical to a shape of the cutting line of the toughened glass plate, wherein the contact part is to come into contact with the cutting line; and
a heater heating the body.

9. The apparatus according to claim 8, wherein the heater is disposed within the body.

10. The apparatus according to claim 5, further comprising a support unit supporting the toughened glass plate to be cut, the support unit cooling the toughened glass plate to be cut.

11. The apparatus according to claim 5, wherein the heating unit has a three-dimensional shape.

12. The apparatus according to claim 5, comprising a plurality of the heating units.
